(19) United States
(12) Patent Application Publication
(10) Pub. No.: US 2010/0139046 A1
(43) Pub. Date: Jun. 10, 2010

(54) PULL ASSEMBLY

(76) Inventors: James Daniels, Stokesdale, NC (US); Victor Hoemig, Lowell, IN (US); Geraint Krumpe, Chicago, IL (US)

Correspondence Address: Carlson, Gaskey & Olds/Masco Corporation, 400 West Maple Road, Suite 350, Birmingham, MI, 48009, US

(21) Appl. No.: 12/329,622

(22) Filed: Dec. 7, 2008

(51) Int. Cl. A47B 95/02; E05B 1/00

(52) U.S. Cl. 16/414; 16/417

(57) ABSTRACT

An example pull assembly includes an insert having a first surface and an oppositely facing second surface. A base has a bore axially extending from a first end that is adapted to receive the insert member. A fastening structure extends from the second surface of the insert. The fastening structure is configured to be secure relative to a mounting surface to hold the base relative to the mounting surface.

### BACKGROUND

This invention relates to a pull, and more particularly, to a removable insert portion of a pull that facilitates securing the pull relative to a mounting surface.

Pulls are well known. Example pulls include cabinet knobs and cabinet handles. Pulls are often used within kitchens, bathrooms, and other interior environments. The pulls provide a handhold used to manipulate a cabinet door or a cabinet drawer into a desired position.

Users often select a pull, or replace an existing pull, based on the pull's ability to aesthetically enhance a surrounding environment. Retail stores offer a variety of pull designs to accommodate user design changes. Manufacturing multiple pulls is costly for the pull manufacturers due in part to the associated tool complexity.

Some pulls include decorative inserts, which are available in a wide variety of shapes, sizes, colors, finishes, etc. Many users replace the insert to change the look of the pull, rather than replacing the entire pull. Changing combinations between the insert and the pull provides the user with more design options than simply replacing the pull. Visually distinguishing between the installed insert and the other portion of the pull is undesirable. For example, gaps between the insert and the other portions of the pull undesirably highlights that the insert is separate from the pull. The gaps between the insert and the other portions of the pull also collect dirt and are difficult to clean. To minimize gapping, pulls often incorporate complicated attachment features used to secure the insert relative to the rest of the pull. Additional attachment features are then used to secure the pull relative to the mounting surface. Providing attachment features that secure the insert relative to the pull, and separate attachment features that secure the pull relative to the mounting surface, is costly.

### SUMMARY

An example pull assembly includes an insert having a first surface and an oppositely facing second surface. A base has a bore axially extending from a first end that is adapted to receive the insert member. A fastening structure extends from the second surface of the insert. The fastening structure is configured to be secure relative to a mounting surface to hold the base relative to the mounting surface.

Another example pull assembly is configured to be secured relative to a mounting surface. The pull assembly includes an insert having a head portion and a stem portion. The head portion of the insert has a first side and a second side opposite the first side. The stem portion of the insert extends from the second side of the head portion. A base includes a bore that extends axially between a first end adapted to receive the insert and a second end adapted to receive a portion of a fastener. The stem portion of the insert is removably engageable with the fastener to hold the base relative to the insert.

An example method of securing a pull assembly relative to a mounting surface includes removably securing an insert relative to a mounting surface and holding a base relative to the mounting surface with the insert.

These and other features of the present invention can be best understood from the following specification and drawings, the following is a brief description of the drawings.

### BRIEF DESCRIPTION OF THE DRAWINGS

FIG. 1 shows an example pull assembly.

FIG. 2 shows an exploded view of the FIG. 1 pull assembly.

FIG. 3 shows a section view through the FIG. 2 pull assembly.

FIG. 4 shows a side view of the insert member of the FIG. 1 pull assembly.

FIG. 5 shows a top view of the insert member of the FIG. 1 pull assembly.

FIG. 6 shows a side view of the base member of the FIG. 1 pull assembly.

FIG. 7 shows a top view of the base member of the FIG. 1 pull assembly.

FIG. 8 shows another example insert member for the FIG. 1 pull assembly.

FIG. 9 shows an exploded view of another example pull assembly.

FIG. 10 shows an assembled view of the FIG. 9 pull assembly.

### DETAILED DESCRIPTION

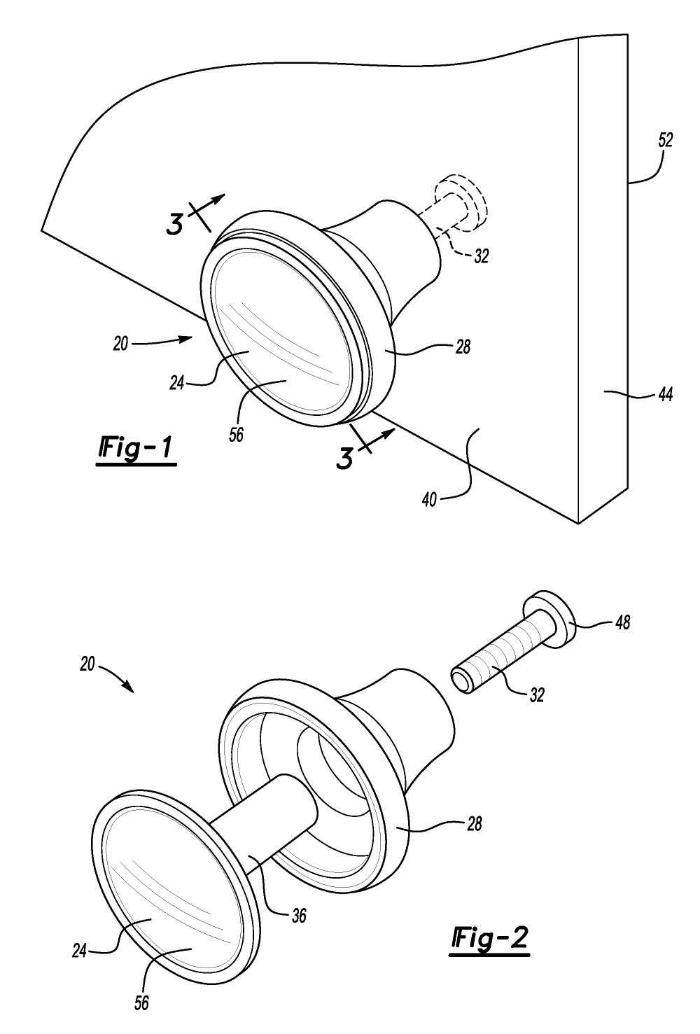

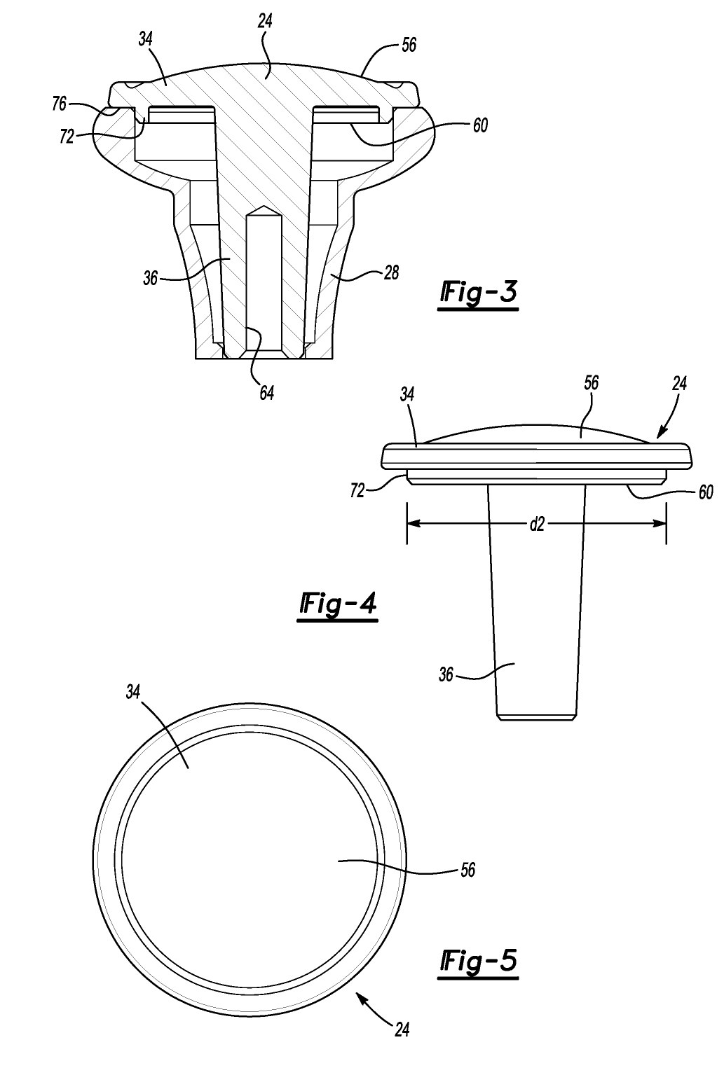

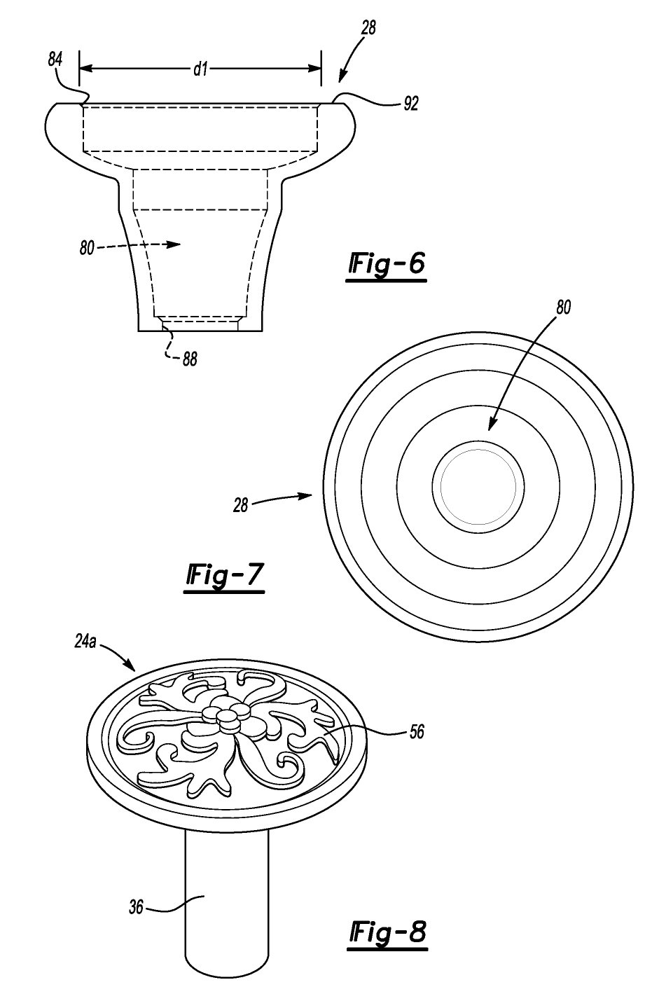

Referring to FIGS. 1-7, an example pull assembly 20 includes an insert member 24 that is received within a base member 28. A stem portion 36 of the insert member 24 is configured to removably engage a fastener 32 to secure the insert member 24 and the base member 28 relative to a mounting surface 40. The stem portion 36 thus provides a fastening structure for the insert member 24. In this example, the mounting surface 40 is an exterior surface of a cabinet door 44. In another example, the mounting surface 40 is the exterior surface of a cabinet drawer.

The fastener 32 includes a fastener head 48 that contacts an interior surface 52 of the cabinet door 44 when the stem portion 36 of the insert member 24 is fully engaged with the fastener 32 that extends through the cabinet door 44. In the engaged position of FIG. 1, the cabinet door 44 and the base member 28 are held between the insert member 24 and the fastener head 48 of the fastener 32.

A head portion 34 of the insert member 24 defines a first surface 56 and a second surface 60, opposite the first surface 56. The stem portion 36 extends from the second surface 60 of the head portion 34 toward the mounting surface 40 when the insert member 24 is received within the base member 28.

When the insert member 24 is received within the base member 28, the first surface 56 is exposed and the second surface 60 is shrouded by the base member 28. The exposed first surface 56 is colored in some examples to provide a desired design. In another example, the exposed first surface is a different material than the base member 28.

In this example, the stem portion 36 of the insert member 24 defines a threaded cavity 64 that is configured to threadably engage the fastener 32, which is a screw in this example. Other example fasteners include bolts or other types of mechanical fasteners, etc. The head portion 34 of the insert member 24 includes features 72 that extend from the second surface 60 to facilitate aligning the insert member 24 within the base member 28 as the threaded cavity 64 engages with the fastener 32.

A user tightens the fastener 32 within the cavity to engage fastener 32 with the threaded cavity 64, which draws the insert member 24 toward the mounting surface 40. As the fastener 32 is tightened within the threaded cavity 64, a portion 76 of the second surface 60 contacts a lip portion 92 of the base member 28. The portion 76 of the second surface 60 holds the base member 28 against the mounting surface 40. The fastener 32 extends from the interior surface 52 through an aperture in the cabinet door 44 to the threaded cavity 64.

The base member 28 has a circular cross-section and defines a bore 80 that extends axially from a first bore end 84 of the base member 28 to a second bore end 88 of the base member 28. The bore 80 receives the stem portion 36 of the insert member 24 as the fastener 32 engages the insert member 24.

In this example, the diameter d₁ of the bore 80 near the first bore end 84 is slightly less than the diameter d₂ of the head portion 34. Accordingly, as the insert member 24 moves within the bore 80, the outer lateral edges of the head portion 34, and particularly the outer later edges of the features 72, interfere slightly with the portions of the bore 80 that define the first bore end 84. The resulting interference fit between the head portion 34 and the base member 28 facilitates holding the insert member 24 within the base member 28, even if the fastener 32 is not engaged within the threaded cavity 64.

In another example, ribs (not shown) extend in radial direction from one of the head portion 34 or the portions of the bore 80 that define the first bore end 84. The ribs facilitate controlling the forces required to install the insert member 24 fully within the bore 80, for example.

Interference fits are known and a person having ordinary skill in this art and having the benefit of this disclosure would be able to establish dimensions for d₁ and d₂, which would result in a interference fit between the base member 28 and the insert member 24 that suitably holds the head portion 34 relative to the base member 28.

In one example, the interference fit between the base member 28 and the insert member 24 is relied on to hold the insert member 24 relative to the base member 28 prior to securing the pull assembly 20 relative to a mounting surface 40, such as when shipping the pull assembly 20 to a retail outlet. The fastener 32 then further secures the insert member 24 relative to the base member 28 as the pull assembly 20 is secured to the pull mounting surface 40, such as when the user secures the pull assembly 20 to an interior cabinet.

In another example, the dimension d₁ is larger than the dimension d₂ and there is no interference fit between the insert member 24 and the base member 28. In such an example, the insert member 24 is secured to the base member 28 only when the pull assembly 20 is secured relative to the pull mounting surface 40.

To change the insert member 24, a user first removes the fastener 32 and then moves the insert member 24 relative to the base member 28 to overcome the interference fit if needed. Once removed, the insert member 24 can be replaced, such as with the insert member 24a shown in FIG. 8. Replacing the insert member 24 with the insert member 24a changes the aesthetic appearance of the pull assembly 20. In another example, the base member 28 is replaced, and the insert member 24 remains the same

The example insert member 24a of FIG. 8 includes molded or etched details that provide a user with design options for the pull assembly 20. Because the insert member 24 is replaced in this example, rather than the entire pull assembly 20, the user achieves a design change without requiring an entirely separately tooled pull assembly.

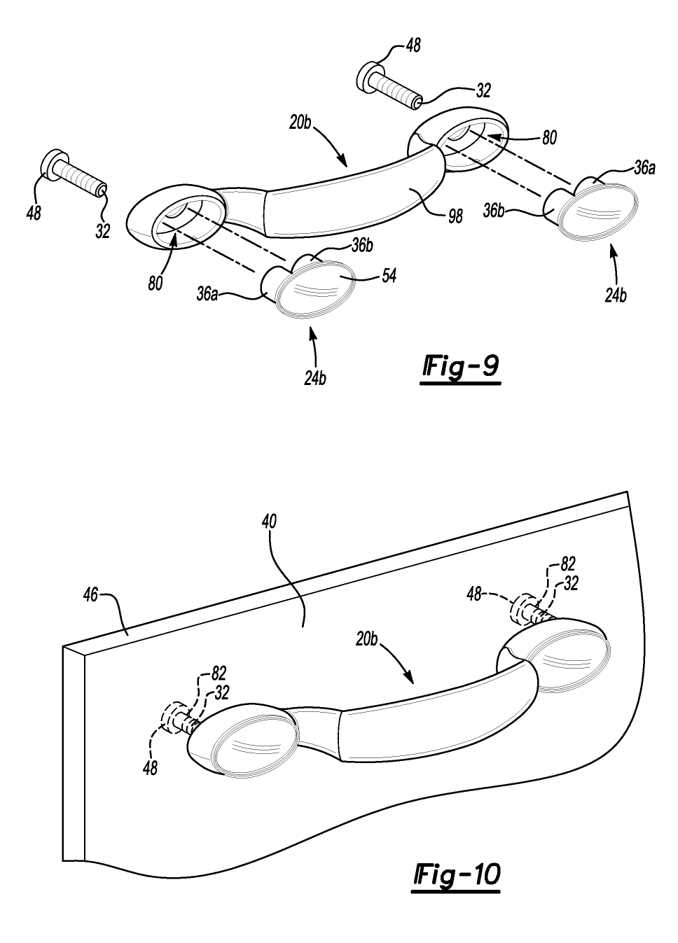

Referring to FIGS. 9 and 10, another example pull assembly 20b includes two insert members 24b that are each secured relative to the pull mounting surface 40. In this example, the mounting surface 40 is an exterior surface of a cabinet drawer 46.

The pull assembly 20b is securable relative to the pull mounting surface 40 with two fasteners 32 and the two insert members 24b. The fasteners 32 and the insert members 24b are each partially received within respective bores 80. The secured insert members 24b hold the pull assembly 20b relative to the mounting surface 40.

In this example, the insert members 24b each include a first stem portion 36a and a second stem portion 36b spaced from the first stem portion 36a. Either stem portion 36a or 36b can receive the fasteners 32. The example pull assembly 20b can thus accommodates multiple pull mounting arrangements by securing the fasteners 32 to the first stem portion 36a or the second stem portion 36b. In this example, apertures 82 through cabinet drawer 46 are spaced 96 mm apart, thus the fasteners 32 are received within the first stem portions 36a of the insert members 24b.

The pull assembly 20b is then also securable to mounting surface 40 or cabinet drawer 46 having a reduced distance between the apertures 82, such as 76.2 mm. In such an example, the fasteners 32 can be received within the second stem portions 36b.

The secured insert members 24b hold the pull assembly 20b relative to the mounting surface 40 whether the fasteners 32 are received in the stem portion 36a or the stem portion 36b.

The example pull assembly 20b includes a handle portion 98 spanning between positions adjacent the two bores 80 and insert members 24b. The user grasps the handle portion to open a drawer, for example. In one example, the insert members 24b are replaced with different insert members 24b to change the aesthetic characteristics of the pull assembly 20b even though the handle portion 98 remains. Thus, the user achieves an aesthetic design change without replacing the entire pull assembly 20b.

Features of the disclosed embodiments include using an insert member to facilitate securing a pull relative to a mounting surface. Another feature includes changing the aesthetics of a pull assembly with relatively minimal tooling impact.

Although a preferred embodiment has been disclosed, a worker of ordinary skill in this art would recognize that certain modifications would come within the scope of this invention. For that reason, the following claims should be studied to determine the true scope and content of this invention.

We claim:

1. A pull assembly, comprising:
an insert having a first surface and a oppositely facing second surface;
a base having a bore axially extending from a first end adapted to receive the insert member; and
a fastening structure extending from the second surface of the insert, the fastening structure configured to be secured relative to a mounting surface to hold the base relative to the mounting surface.

2. The pull assembly of claim 1, wherein the pull mounting surface is at least one of a cabinet drawer face or a cabinet door face.

3. The pull assembly of claim 1, wherein the fastening structure comprises a threaded portion.

4. The pull assembly of claim 1, wherein the base comprises a lip, a portion of the second surface held against the lip when the fastening structure is secured relative to the mounting surface.

5. The pull assembly of claim 1, comprising a fastener configured to threadably engage the fastening structure to secure the fastening structure relative to the mounting surface.

6. The pull assembly of claim 1, wherein the base has a circular radial cross-section.

7. The pull assembly of claim 1, wherein the base comprises a second bore adapted to receive a second insert member.

8. The pull assembly of claim 7, including a handle portion of the base extending between the portions of the base establishing the bore and the portions of the base establishing the second bore.

9. A pull assembly configured to be secured relative to a mounting surface, comprising:
an insert having a head portion and a stem portion,
the head portion of the insert having a first side and a second side opposite the first side,
the stem portion of the insert extending from the second side of the head portion; and
a base having a bore extending axially between a first end adapted to receive the insert and a second end adapted to receive at least a portion of a fastener, wherein the stem portion of the insert is removably engageable with the fastener to hold the base relative to the insert.

10. The pull assembly of claim 9, wherein an interference fit between the insert and the base holds the insert within the base.

11. The pull assembly of claim 9, wherein the insert attachment structure is removably engageable with the fastener to hold the base and the insert head portion relative to a mounting surface.

12. The pull assembly of claim 9, wherein the second side contacts the base to hold the base relative to the mounting surface when the stem portion of the insert is engaged with the fastener.

13. The pull assembly of claim 9, wherein the head portion of the insert interferes with the base to hold the insert relative to the base.

14. A method of securing a pull assembly relative to a mounting surface, comprising:
(a) removably securing an insert relative to a mounting surface; and
(b) holding a base relative to the mounting surface with the insert.

15. The method of claim 14, including holding the insert relative to the base using an interference fit.
